(19) United States
(12) Patent Application Publication
(10) Pub. No.: US 2004/0172170 A1
(43) Pub. Date: Sep. 2, 2004

(54) Portable wheel alignment device

(76) Inventor: Brooks R. Lesert, Middleville, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/725,750

(22) Filed: Dec. 2, 2003

Related U.S. Application Data
(60) Provisional application No. 60/430,286, filed on Dec. 2, 2002.

(51) Int. Cl. G01M 1/38

(52) U.S. Cl. 700/279; 356/139.09

(57) ABSTRACT

A portable wheel alignment apparatus comprising a portable unit, at least one light reflector and at least one docking station for the portable unit. The portable unit includes a vertical post having a camera boom thereon, with the camera boom being adapted to move vertically on the vertical post. The at least one light reflector is adapted to be connected to a wheel of a vehicle. Each of the at least one docking station is configured to be positioned in front of a bay for a vehicle whereby the portable unit can be removably positioned in the at least one docking station and an alignment of the wheels of the vehicle in the bay can be measured through interaction of the camera boom and the at least one light reflector.

### CROSS-REFERENCE TO RELATED APPLICATION

This application claims priority to U.S. Provisional Patent Application Serial No. 60/430,286 filed on Dec. 2, 2002 entitled PORTABLE WHEEL ALIGNMENT DEVICE.

### BACKGROUND OF THE INVENTION

The present invention relates to a vehicle wheel alignment device, and in particular to a portable wheel alignment device.

Wheel alignment devices are used to align the wheels of a vehicle. The wheel alignment devices measure various characteristics of the alignment of the wheels, including toe-in, camber and caster of the wheels. Aligning the wheels of the vehicle decreases any shaking of the vehicle to provide for a pleasant riding environment for passengers in the vehicle. Furthermore, aligning the wheels of the vehicle can prolong the life of the wheels.

Heretofore, wheel alignment devices have included a light source, a camera and a light reflector. The light reflector is secured to the wheel of the vehicle and the light source projects light off of the reflector and into the camera. The camera is connected to a computer that receives light measurements from the camera and determines the alignment of the wheels. An example of the interaction between the light source and a reflector 14 is disclosed in U.S. Pat. No. 3,963,352, entitled WHEEL ALIGNMENT APPARATUS. Typically, the camera is located on a camera boom or its equivalent secured to a building or garage. Furthermore, each camera boom could only determine the alignment of a vehicle in one spot. Therefore, several expensive camera booms would be needed to measure the alignment of several vehicles at one time. Another wheel alignment device has included a portable camera that could be moved from vehicle to vehicle. The portable camera is included in the V3D-Gold Aligner sold by John Bean of Conway, Ark. However, properly positioning the portable camera can sometimes be difficult, thereby reducing the accuracy of the alignment of the wheels using the prior art portable camera.

Accordingly, a wheel alignment apparatus solving the aforementioned disadvantages and having the aforementioned advantages is desired.

### SUMMARY OF THE INVENTION

One aspect of the present invention is to provide a portable wheel alignment apparatus comprising a portable unit, at least one light reflector and at least one docking station for the portable unit. The portable unit includes a vertical post having a camera boom thereon, with the camera boom being adapted to move vertically on the vertical post. The at least one light reflector is adapted to be connected to a wheel of a vehicle. Each of the at least one docking station is configured to be positioned in front of a bay for a vehicle whereby the portable unit can be removably positioned in the at least one docking station and an alignment of the wheels of the vehicle in the bay can be measured through interaction of the camera boom and the at least one light reflector.

Another aspect of the present invention is to provide a method of measuring the alignment of a wheel of a vehicle. The method includes providing a portable unit including a vertical post, with the vertical post having a camera boom with a camera thereon. The method further includes connecting a light reflector to the wheel of the vehicle, engaging the portable unit with a docking station, moving the camera boom vertically on the vertical post, reflecting light off of the light reflector and receiving the light reflected off of the light reflector with the camera.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a schematic plan view of a garage having a portable wheel alignment apparatus embodying the present invention.

FIG. 2 is a front view of a portable unit of the portable wheel alignment apparatus embodying the present invention.

FIG. 3 is a top view of a portable unit of the portable wheel alignment apparatus embodying the present invention.

FIG. 4 is a side view of a portable unit of the portable wheel alignment apparatus embodying the present invention.

FIG. 5 is a front view of a docking station of a first embodiment of the present invention.

FIG. 6 is a top view of the docking station of the first embodiment of the present invention.

FIG. 7 is a side view of the docking station of the first embodiment of the present invention.

FIG. 8 is a front view of a second embodiment of the portable wheel alignment apparatus unit embodying the present invention.

FIG. 9 is a side view of the second embodiment of the portable wheel alignment apparatus unit embodying the present invention.

FIG. 10 is a cross-sectional view of the second embodiment of the portable wheel alignment apparatus unit embodying the present invention.

FIG. 11 is a top view of a floor mounted overhead track of the second embodiment of the portable wheel alignment apparatus unit embodying the present invention.

FIG. 12 is a top view of a straight section of the overhead track.

FIG. 13 is a top view of a curved section of the overhead track.

FIG. 14 is a front view of a third embodiment of the portable unit of the present invention.

### DETAILED DESCRIPTION OF THE PREFERRED EMBODIMENT

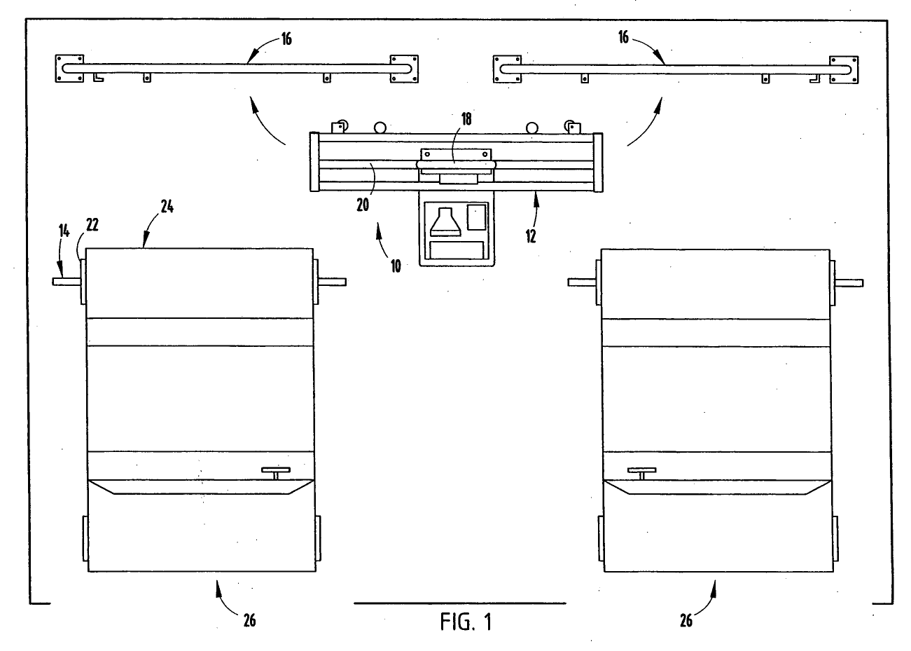

For purposes of description herein, the terms “upper,” “lower,” “right,” “left,” “rear,” “front,” “vertical,” “horizontal,” and derivatives thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The reference number 10 (FIG. 1) generally designates a portable wheel alignment apparatus embodying the present invention. In the illustrated example, the portable wheel alignment apparatus 10 comprises a portable unit 12, at least one light reflector 14 and at least one docking station 16 for the portable unit 12. The portable unit 12 includes a vertical post 18 having a camera boom 20 thereon, with the camera boom 20 being adapted to move vertically on the vertical post 18. The at least one light reflector 14 is adapted to be connected to a wheel 22 of a vehicle 24. Each of the at least one docking station 16 is configured to be positioned in front of a bay 26 for a vehicle whereby the portable unit 12 can be removably positioned in the at least one docking station 16 and an alignment of the wheels 22 of the vehicle 24 in the bay 26 can be measured through interaction of the camera boom 20 and the at least one light reflector 14.

The at least one light reflector 14 and the camera boom 20 comprise the components of a wheel alignment system. Wheel alignment systems are well known to those skilled in the art. In wheel alignment systems, light comes from a light source (not shown) in the camera boom and is bounced off of the light reflector back to the camera boom to measure the alignment of the wheel. An example of the interaction between the light source in the camera boom 20 and a light reflector 14 is disclosed in U.S. Pat. No. 3,963,352, entitled WHEEL ALIGNMENT APPARATUS, the entire contents of which are hereby incorporated herein by reference. The camera boom 20 and the light reflector can also be found in the V3D-Gold Aligner sold by John Bean of Conway, Ark.

In the illustrated example, the portable unit 12 can be moved from vehicle to vehicle to measure the alignment of several different vehicles, unlike the prior art which typically had a camera boom or its equivalent secured to the building or garage and each camera boom could only determine the alignment of a vehicle in one spot. The docking stations 16 in a first embodiment of the portable wheel alignment apparatus 10 include a docking fence 28 located at the end of each bay 26. The docking fence 28 is configured to lock to the portable unit 12 to lock the portable unit 12 in position. In the illustrated example, the portable wheel alignment apparatus includes two docking stations 16, although it is contemplated that any number of docking stations could be used.

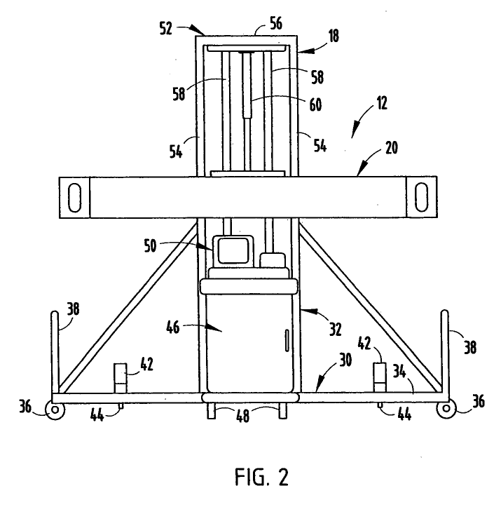

The illustrated portable unit 12 (FIGS. 2-4) includes a base 30, a computer console 32, the camera boom 20 and the vertical post 18 for raising and lowering the camera boom 20. The base 30 includes a rectangular horizontal frame 34 on rollers 36. A push bar 38 extends upward from each end of the frame 34 for moving the portable unit 12. The base 30 also includes a pair of bump rollers 40 extending horizontally from a rear end of the base 30. As explained in more detail below, the bump rollers 40 are configured to abut against the docking fence 28 as the portable unit 12 is docked with the docking stations 16. The base 30 also includes a pair of air cylinders 42 that force a pin 44 downward. The pin 44 is used to lock the portable unit 12 in position with the docking stations 16. The computer console 32 is a cabinet 46 on rollers 48 connected to a front portion of the base 30. The computer console 32 is configured to have a computer 50, a monitor, a keyboard, a mouse, a printer and other computer components placed thereon for use during alignment of the wheels. The use of the computer in alignment of wheels is well known to those skilled in the art.

In the illustrated example, the vertical post 18 extends upwardly from the base 30 and carries the camera boom 20. The vertical post 18 includes a frame 52 comprising a pair of side frame members 54 and a top frame member 56. A pair of guide rods 58 extend between the top frame member 56 and the frame 34 of the base 30. The camera boom 20 includes a pair of slots (not shown) that accept the guide rods 58 and the camera boom 20 is configured to move vertically on the guide rods 58. The guide rods 58 also include linear bearings to assist in vertical movement of the camera boom 20. A cylinder 60 connected to the top frame member 56 moves the camera boom 20 vertically. It is contemplated that the cylinder 60 can be hydraulically or pneumatically driven. It is further contemplated that a pulley could be used to lift the camera boom 20 and air cylinders that selectively open could allow the camera boom to lower under its own weight. Preferably, an electric line and a hydraulic/pneumatic line extend from the building to the mobile unit 12 to power the camera boom 20, the computer 50 and the cylinder 60.

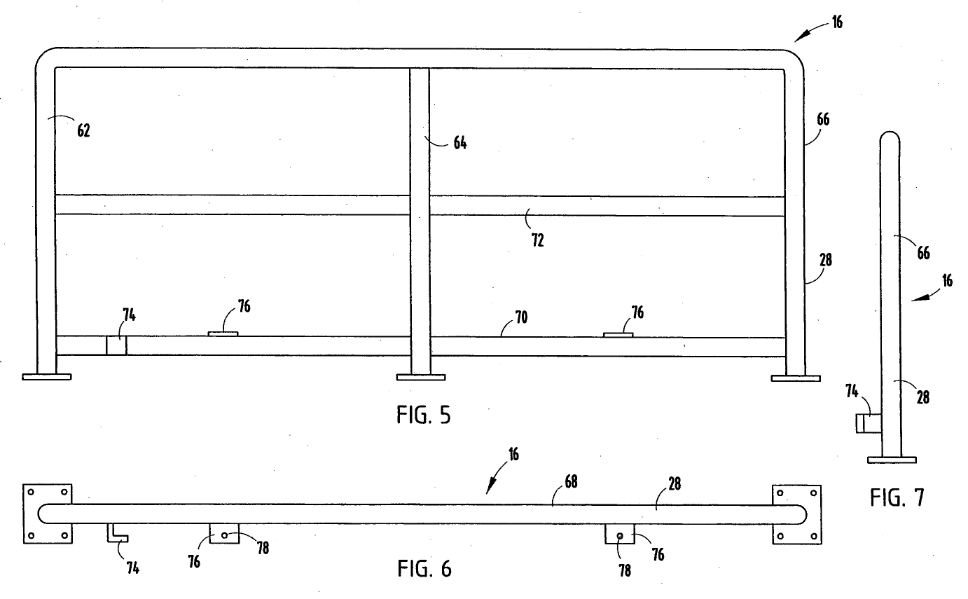

The illustrated docking fence 28 (FIGS. 5-7) of the docking stations 16 is secured to the floor in front of the bay 26 for the vehicle 24. The docking fence 28 includes a left side post 62 connected to the floor, a center post 64 connected to the floor and a right side post 66 connected to the floor. The docking fence 28 also includes a top member 68, a bottom member 70 and a middle member 72 extending horizontally between the left side post 62 and the right side post 66. The bottom member 70 includes an L-shaped lock stop 74 extending forwardly therefrom. The bottom member 70 also includes a pair of lock plates 76 having holes 78 therein extending from the bottom member 70. The lock stop 74 and the lock plates 76 are used to lock the portable unit 12 to the docking station 16.

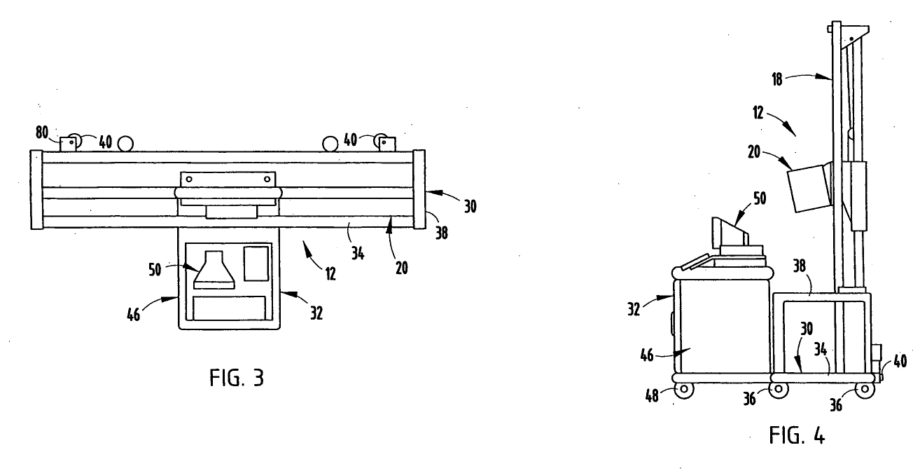

The portable unit 12 is locked into position at the chosen docking station 16 by first pushing the portable unit 12 against the docking station 16 until the bumper rollers 40 abut against the bottom member 70 of the docking fence 28. Thereafter, the portable unit 12 is pushed to the left until the lock stop 74 is inserted into a groove 80 (see FIG. 3) on one of the housings for the bumper rollers 40. At this point, the pair of air cylinders 42 force the pins 44 downward until the pins 44 protrude through the holes 78 in the lock plates 76. At this point, the portable unit 12 is locked into position and the alignment of the wheels 22 of the vehicle 24 can be made. To move the portable unit 12 to another docking station 16, the pin 44 is withdrawn back into the cylinder 42 and the portable unit 12 is pushed or pulled to the other docking station 16, where the portable unit 12 is locked into position as described above.

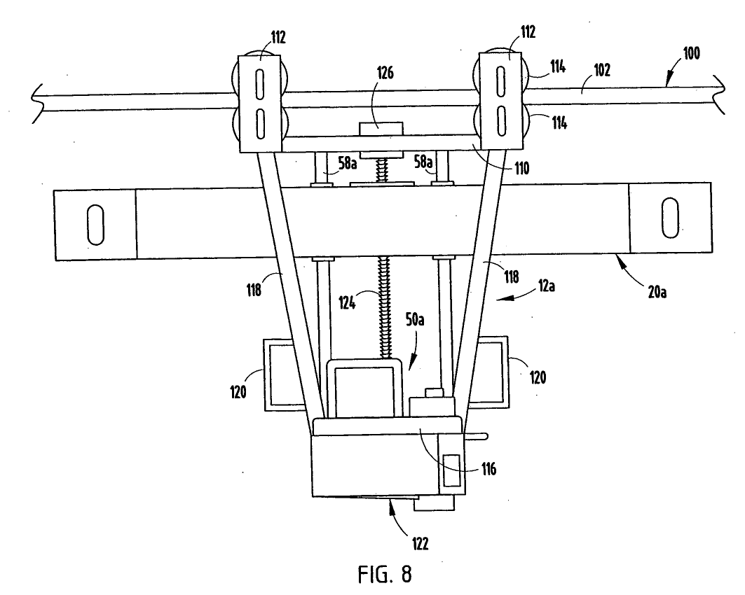

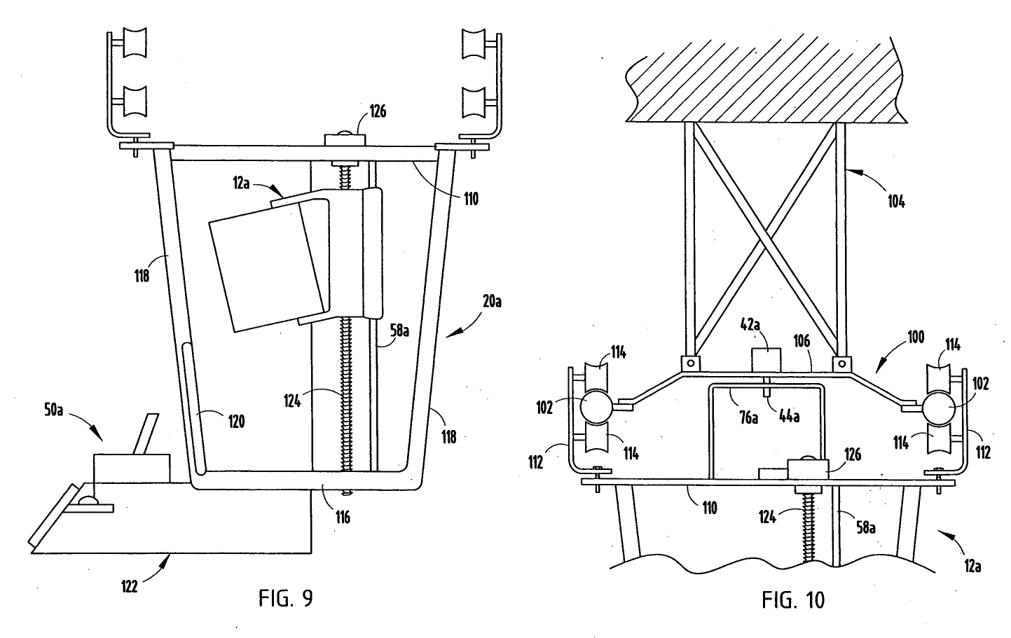

The reference numeral 10a (FIGS. 8-11) generally designates another embodiment of the present invention, having a second embodiment for the portable wheel alignment apparatus unit. Since the portable wheel alignment apparatus 10a is similar to the previously described portable wheel alignment apparatus 10, similar parts appearing in FIGS. 1-7 and FIGS. 8-11, respectively, are represented by the same, corresponding reference number, except for the suffix “a” in the numerals of the latter. The portable wheel alignment apparatus 10a includes a portable unit 12a connected to an overhead track 100. The at least two docking stations 16a are incorporated into the overhead track 100.

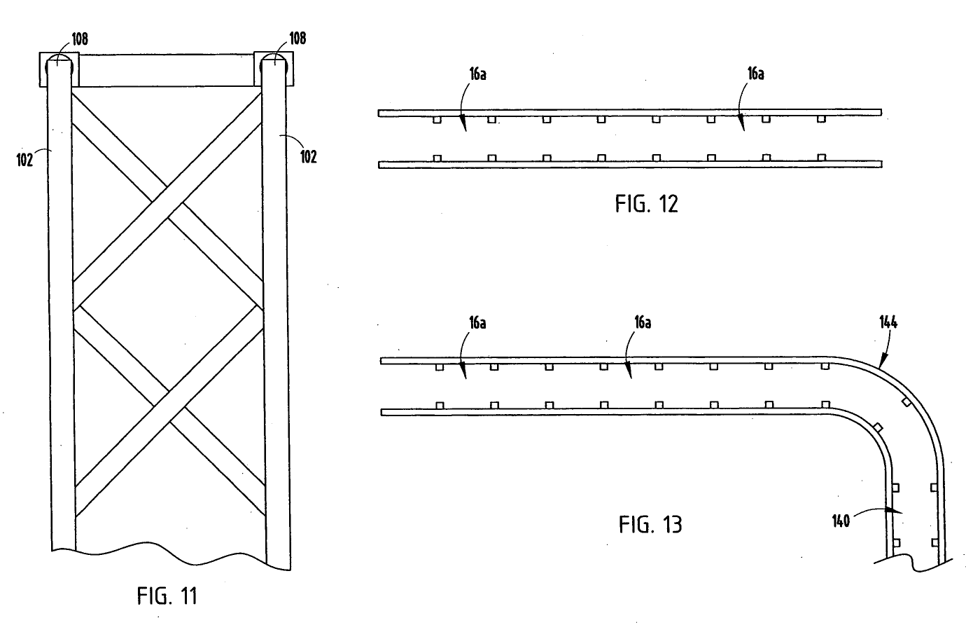

In the illustrated example, the overhead track 100 includes a pair of rails 102 upon which the portable unit 12a moves. The pair of rails 102 can be connected to the ceiling by struts 104 and a rail bracket 106 (FIG. 10) or the pair of rails 102 can be mounted between a pair of posts 108 mounted to the floor (FIG. 11). In either situation, the portable unit 12a includes a top plate 110 having four roller mounts 112 extending upwardly therefrom and pivotally connected thereto. Each roller mount 112 includes a pair of rollers 114 accepting one of the rails 102 therebetween. The portable unit 12a is therefore allowed to move between the two docking stations 16a along the overhead track 100.

The illustrated portable unit 12a includes a bottom support 116 connected to the top plate 110 by four braces 118. Two of the braces 118 include a push handle 120 for easily moving the portable unit 12a into position on the overhead track 100. The bottom support 116 also includes a computer support 122. The computer support 122 is configured to support a computer 50a and all of the components thereof. A lift screw 124 extends between the bottom support 116 and the top plate 110. The lift screw 124 is connected to the camera boom 20a and is configured to move the camera boom 20a vertically on the guide rods 58a. A drive motor 126 is connected to the top plate 110 to rotate the lift screw 124 in order to move the camera boom 20a vertically. It is further contemplated that a pulley could lift the camera boom 20a and selectively opening air springs could allow the camera boom 20a to lower under its own weight.

In the illustrated example, the portable unit 12a is locked into position by moving the portable unit 12a into proper position and activating a cylinder 42a connected to the overhead track 100 that inserts a pin 44a through a hole in a lock plate 76a extending upwardly from the top plate 110 of the portable unit 12a (see FIG. 10). The portable unit 12a is therefore locked in position and the alignment of the wheels 22 of the vehicle 24 can be made. To move the portable unit 12a to another docking station 16a, the pin 44a is withdrawn back into the cylinder 42a and the portable unit 12a is pushed or pulled to the other docking station 16a.

FIGS. 12 and 13 illustrate two portions of the overhead track 100. FIG. 12 shows a straight section of the overhead track 100 that could include at least two docking stations 16a. FIG. 13 shows a curved section of the overhead track 100 that could include at least two docking stations 16a and a storage section 140 when it is desired to move the portable unit 12a out of the way in the garage having the bays 26. As discussed above, the four roller mounts 112 are pivotally connected to the top plate 110, thereby allowing the portable unit 12a to move around a bend 144 in the curved section of the overhead track 100.

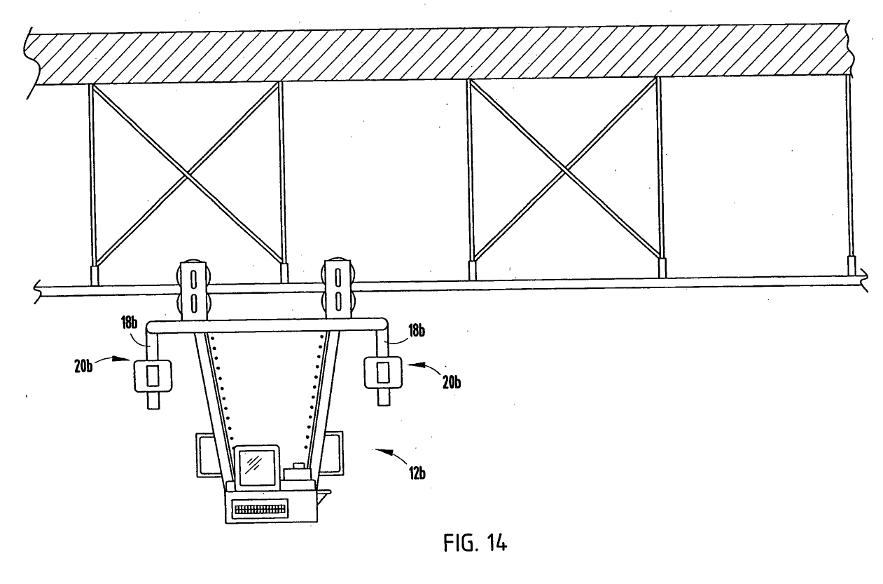

The reference numeral 12b (FIG. 14) generally designates another embodiment of the present invention, having a third embodiment for the portable unit. Since the portable unit 12b is similar to the previously described portable unit 12a, similar parts appearing in FIGS. 8-11 and FIG. 14, respectively, are represented by the same, corresponding reference number, except for the suffix “b” in the numerals of the latter. The portable unit 12b is identical to the previously described portable unit 12a, except that the portable unit 12b includes a pair of cameras on camera booms 20b that extend from a hanging vertical post 18b. Each camera boom 20b is configured to move vertically on the hanging vertical post 18b.

The above description is considered that of the preferred embodiments only. Modification of the invention will occur to those skilled in the art and to those who make or use the invention. For example, it is contemplated that the cylinder 42 could be a spring loaded cylinder that pulls on a pin instead of pushing the pin 44. Therefore, the spring would keep the pin in position and the cylinder could be connected to a hydraulic or pneumatic line to actuate the pin. Furthermore, it is contemplated that pin 44 could be J-shaped and the cylinder could lift the J-shaped pin into engagement with the hole 78 in the lock plate 76. Moreover, the pin and the hole 78 could each be tapered to help center the portable unit 12 into position at the docking station 16. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A portable wheel alignment apparatus comprising:
a portable unit including a vertical post, the vertical post having a camera boom thereon, the camera boom being adapted to move vertically on the vertical post;
at least one light reflector adapted to be connected to a wheel of a vehicle; and
at least one docking station for the portable unit, each one of the at least one docking station being configured to be positioned in front of a bay for a vehicle whereby the portable unit can be removably positioned in the at least one docking station and an alignment of the wheels of the vehicle in the bay can be measured through interaction of the camera boom and the at least one light reflector.

2. The portable wheel alignment apparatus of claim 1, wherein:
the at least one docking station comprises at least two docking stations.

3. The portable wheel alignment apparatus of claim 1, wherein:
the camera boom of the portable unit includes at least one camera.

4. The portable wheel alignment apparatus of claim 3, wherein:
the at least one camera comprises two cameras.

5. The portable wheel alignment apparatus of claim 1, wherein:
the portable unit further includes a computer for determining the alignment of the wheels of the vehicle.

6. The portable wheel alignment apparatus of claim 1, wherein:
the portable unit includes a hydraulically or pneumatically driven cylinder for moving the camera boom vertically on the vertical post.

7. The portable wheel alignment apparatus of claim 1, wherein:
the portable unit and the at least one docking station include engaging mating structure; and
the engaging mating structure properly position the portable unit in the at least one docking station when engaged.

8. The portable wheel alignment apparatus of claim 1, wherein:
a first one of the portable unit and the at least one docking station include a retractable pin and a second one of the portable unit and the least one docking station include an opening; and
the retractable pin is configured to be inserted into the opening to lock the portable unit in place in the at least one docking station.

9. The portable wheel alignment apparatus of claim 1, wherein:
the portable unit includes at least one bump roller;
the at least one docking station includes a front face; and
the at least one bump roller is configured to roll on the front face of the at least one docking station as the portable unit is positioned in the at least one docking station.

10. The portable wheel alignment apparatus of claim 1, wherein:
the portable unit includes at least one push bar for easily moving the portable unit.

11. The portable wheel alignment apparatus of claim 1, wherein:
the at least one docking station is incorporated into a track; and
the portable unit includes rollers slidable along the track.

12. The portable wheel alignment apparatus of claim 11, wherein:
the track is configured to be attached to a ceiling of the bay.

13. The portable wheel alignment apparatus of claim 11, wherein:
the track includes a pair of support posts configured to be mounted to a floor of the bay.

14. The portable wheel alignment apparatus of claim 11, wherein:
the track is straight.

15. The portable wheel alignment apparatus of claim 11, wherein:
the track includes at least one curved section.

16. A method of measuring the alignment of a wheel of a vehicle comprising:
providing a portable unit including a vertical post, the vertical post having a camera boom with a camera thereon;
connecting a light reflector to the wheel of the vehicle;
engaging the portable unit with a docking station;
moving the camera boom vertically on the vertical post;
reflecting light off of the light reflector; and
receiving the light reflected off of the light reflector with the camera.

17. The method of measuring the alignment of a wheel of a vehicle of claim 16, further including:
moving the portable unit to a subsequent station for docking the portable unit;
engaging the portable unit with the subsequent station;
moving the camera boom vertically on the vertical post;
connecting a secondary light reflector to a subsequent wheel of a subsequent vehicle;
reflecting light off of the secondary light reflector; and
receiving the light reflected off of the secondary light reflector with the camera.

18. The method of measuring the alignment of a wheel of a vehicle of claim 16, wherein:
providing a portable unit includes providing the camera boom with at least one camera.

19. The method of measuring the alignment of a wheel of a vehicle of claim 18, wherein:
the at least one camera comprises two cameras.

20. The method of measuring the alignment of a wheel of a vehicle of claim 16, wherein:
providing a portable unit includes providing the portable unit with a computer; and
further including determining the alignment of the wheels of the vehicle with the computer.

21. The method of measuring the alignment of a wheel of a vehicle of claim 16, wherein:
providing a portable unit includes providing the portable unit with a hydraulically or pneumatically driven cylinder; and
moving the camera boom vertically on the vertical post includes moving the camera boom vertically with the hydraulically or pneumatically driven cylinder.

22. The method of measuring the alignment of a wheel of a vehicle of claim 16, further including:
providing the portable unit and the docking station with engaging mating structure; and
engaging the engaging mating structure to properly position the portable unit in the docking station.

23. The method of measuring the alignment of a wheel of a vehicle of claim 16, further including:
providing a first one of the portable unit and the docking station with a retractable pin and a second one of the portable unit and the docking station with an opening; and
inserting the retractable pin into the opening to lock the portable unit in place in the docking station.

24. The method of measuring the alignment of a wheel of a vehicle of claim 16, wherein:
providing a portable unit includes providing the portable unit with at least one bump roller; and
engaging the portable unit with a docking station includes rolling the at least one bump roller on a front face of the docking station.

25. The method of measuring the alignment of a wheel of a vehicle of claim 16, wherein:
providing a portable unit includes providing the portable unit with at least one push bar; and
further including moving the portable unit by pushing on the push bar.

26. The method of measuring the alignment of a wheel of a vehicle of claim 16, wherein:
the docking station is incorporated into a track; and
the portable unit includes rollers slidable along the track.

27. The method of measuring the alignment of a wheel of a vehicle of claim 26, further including:
attaching the track to a ceiling.

28. The method of measuring the alignment of a wheel of a vehicle of claim 26, wherein:
the track includes a pair of support posts configured to be mounted to a floor of the bay.

29. The method of measuring the alignment of a wheel of a vehicle of claim 26, wherein:
the track is straight.

30. The method of measuring the alignment of a wheel of a vehicle of claim 26, wherein:
the track includes at least one curved section.

31. A portable wheel alignment apparatus comprising:
a portable unit including a camera boom vertically movable thereon, the camera boom including at least one camera;
at least one light reflector adapted to be connected to a wheel of a vehicle; and
at least two docking stations for the portable unit, each one of the at least two docking stations being configured to be positioned in front of a bay for a vehicle whereby the portable unit can be removably positioned in the at least one docking station and an alignment of the wheels of the vehicle in the bay can be measured through interaction of the camera boom and the at least one light reflector;
wherein the portable unit and each of the at least two docking stations include engaging mating structure; and
the engaging mating structure engage to selectively position the portable unit in one of the at least two docking stations.
